(19) United States
(12) Patent Application Publication
(10) Pub. No.: US 2014/0120510 A1
(43) Pub. Date: May 1, 2014

(54) METHODS and SYSTEMS for ENCOURAGING END-OF-LIFE PLANNING

(71) Applicant: Jeremy Blanchard, Deming, WA (US)

(72) Inventor: Jeremy Blanchard, Deming, WA (US)

(21) Appl. No.: 13/665,873

(22) Filed: Oct. 31, 2012

(51) Int. Cl. G09B 3/00

(52) U.S. Cl. CPC G09B 3/00
USPC 434/322

(57) ABSTRACT

A method for encouraging end-of-life planning. The method includes accessing a computer server having a computer-readable storage medium. The method further includes retrieving a plurality of web documents from the computer server. Each web document includes at least one question directed to end-of-life issues. The method further includes entering data into the web documents. The data is configured to be at least one answer to at least one of the questions. The method further includes incorporating the at least one answer into a template configured to be easily understood.

### CROSS REFERENCE TO RELATED APPLICATION

This application does not claim priority from any other application.

### COPYRIGHT PROTECTION

The disclosure of this patent document includes copyright material. The copyright owner maintains and reserves all copyright protection available.

### TECHNICAL FIELD

This invention relates to methods and systems for encouraging end-of-life planning.

### BACKGROUND OF THE INVENTION

A person's freedom to make decisions and choices regarding personal health care including medical services and procedures, and having those decisions implemented accurately when needed, is paramount. Even more important is a person's end of life decisions and choices directed to health care (also referred to generally as end-of-life health-care planning or end-of-life planning). Potential or imminent death sharpens the importance of end-of-life health care decisions and choices. However, if a person's end-of-life planning is not memorialized; or memorialized but not retrievable by the people needing the information such as health care providers or people communicating to the health care providers; or retrievable but not readily understood, that is, the overall intent or spirit of the end-of-life planning; then implementing the person's end-of-life planning will be elusive at best and non-existent at worst. Exemplary end-of-life health-care planning includes whether life support procedures and heroic medical intervention procedures are to be provided such as intubation, forced feeding, transfusions, cardiopulmonary resuscitation and other heroic medical intervention procedures.

The importance of end-of-life health-care planning is demonstrated by the studies that have shown that over 95% of patients in a critically ill situation are incapacitated leaving them unable to communicate end-of-life choices. And yet, critically ill situations routinely require end-of-life decisions. Consequently, the critically ill patient is incapable of communicating end-of-life desires when death may be imminent. To address this problem, another person, a decision-maker, will routinely have to make those decisions for the critically ill patient. If end-of-life plans for the patient do not exist, or are not accessible, the decision-maker will have to substitute their own end-of-life desires for the critically ill patient. Consequently, a great burden is placed on the decision-maker. The decision-maker is making end-of-life choices for a dying patient without the benefit to verify the accuracy of the substituted end-of-life decisions. In fact, one study has shown that 80% of decision-makers making choices for family members which involved withdrawing life support or withholding heroic medical intervention that ultimately resulted in death caused the decision-maker to develop Post Traumatic Stress Disorder.

Therefore, end-of-life planning is needed before a person becomes incapacitated and unable to communicate their end-of-life choices. However, pre-planning is not enough. The end-of-life planning must be readily accessible and easily understood. Moreover, since preparing for death is difficult for most, particularly when a person is in good health and there is a strong tendency to think there is always time to deal with end-of-life planning, the planning must be a simple endeavor to encourage the pre-planning.

Federal and State governments have attempted to encourage end-of-life planning. At the state level, “advance directives” were formulated in the 1970s. State-level advanced directives are state-enforced legal documents, and in the event that a patient is incapacitated, provide instructions for health care and/or name a decision-maker to provide instructions. At the Federal level, and with the added goal of reining in the spiraling-out-of-control cost of health care, the U.S. Congress passed the Patient Self-Determination Act (hereinafter “the Act”) in 1990. The Act promulgates a different method to encourage advanced directives. The Act requires health care institutions receiving federal Medicare and Medicaid funds to inform patients of their rights to participate in their health care decisions.

However, the use of advanced directives at the Federal and State levels remains low and the reasons are numerous:
Legal and content-related barriers included poor readability (that is, laws in all states were written above a 12^{th}-grade reading level), health care agent or surrogate restrictions (for example, 40 states did not include same-sex or domestic partners as default surrogates), and execution requirements needed to make forms legally valid (for example, 35 states did not allow oral advance directives, and 48 states required witness signatures, a notary public, or both). Vulnerable populations most likely to be affected by these barriers included patients with limited literacy, limited English proficiency, or both who cannot read or execute advance directives; same-sex or domestic partners who may be without legally valid and trusted surrogates; and unbefriended, institutionalized, or homeless patients who may be without witnesses and suitable surrogates.
   Lost in Translation: The Unintended Consequences of Advance Directive Law on Clinical Care by Lesley S. Castillo, BA; Brie A. Williams, MD; Sarah M. Hooper, JD; Charles P. Sabatino, JD; Lois A. Weithorn, PhD, JD; and Rebecca L. Sudore, MD; Annals of Internal Medicine, Volume 154, Number 2, January, 2011, at page 121 of pages 121-128; Copyright © American College of Physicians.

The study concludes:
In conclusion, unintended negative consequences of legal restrictions and requirements related to poor readability of advance directives; health care agent restrictions; execution requirements; insufficient reciprocity; and lack of attention to religious, cultural, and social issues may prevent all patients, and particularly vulnerable patients, from making and communicating their end-of-life wishes and having them honored. In an attempt to safeguard patient autonomy, legal restrictions have rendered advance directives less clinically useful. In addition, advance directive laws seem to protect physicians more than patients.
   Id. at page 126.

Methods, services, systems and devices are needed to facilitate and to encourage people to memorialize end-of-life health-care planning, when they are competent to make such decisions and choices. That is, there is a need to provide a service to facilitate and encourage people to memorialize end-of-life planning and document these end-of-life health-care choices and decisions. Furthermore, there is a need to establish methods, services, systems and devices that allow for maintenance and modification of the documented end-of-life planning. Still further, the methods, services, systems and devices need to make the end-of-life planning readily accessibility and easily understood particularly by people who may have to communicate the end-of-life decisions and choices of the patient to health care providers.

While the inventions disclosed herein were motivated in addressing exemplary issues discussed throughout this document, the inventions in no way are so limited. Other aspects and implementations of the various exemplary inventions are contemplated.

### BRIEF DESCRIPTION OF THE DRAWINGS

Preferred embodiments of the invention are described below with reference to the following accompanying drawings.

FIG. 1 illustrates an exemplary one of the web documents according to an exemplary one of the various embodiments of the inventions.

FIG. 2 illustrates an exemplary one of the web documents according to an exemplary one of the various embodiments of the inventions.

FIG. 3 illustrates an exemplary one of the web documents according to an exemplary one of the various embodiments of the inventions.

FIG. 4 illustrates an exemplary one of the web documents according to an exemplary one of the various embodiments of the inventions.

FIG. 5 illustrates an exemplary one of the web documents according to an exemplary one of the various embodiments of the inventions.

FIG. 6 illustrates an exemplary one of the web documents according to an exemplary one of the various embodiments of the inventions.

FIG. 7 illustrates an exemplary one of the web documents according to an exemplary one of the various embodiments of the inventions.

FIG. 8 illustrates an exemplary one of the web documents according to an exemplary one of the various embodiments of the inventions.

FIG. 9 illustrates an exemplary one of the web documents according to an exemplary one of the various embodiments of the inventions.

FIG. 10 illustrates an exemplary one of the web documents according to an exemplary one of the various embodiments of the inventions.

FIGS. 11A and 11B illustrate an exemplary one of the devices configured as an exemplary narrative according to an exemplary one of the various embodiments of the inventions.

FIG. 12 illustrates an exemplary one of the web documents according to an exemplary one of the various embodiments of the inventions.

FIG. 13 illustrates an exemplary one of control circuitry that uses the web documents of FIGS. 1-10 and 12 according to an exemplary one of the various embodiments of the inventions.

FIG. 14 illustrates an exemplary one of the systems that uses the web documents of FIGS. 1-10 and 12 according to an exemplary one of the various embodiments of the inventions.

FIG. 15 illustrates an exemplary one of the subsystems according to an exemplary one of the various embodiments of the inventions used in combination with the system of FIG. 13.

FIG. 16 illustrates an exemplary one of the methods that uses the web documents of FIGS. 1-10 and 12 in an exemplary one, or all, of the systems of FIGS. 13-15 to create an exemplary narrative of FIG. 11 according to an exemplary one of the various embodiments of the inventions.

FIG. 17 illustrates an exemplary another one of the methods that uses the web documents of FIGS. 1-10 and 12 in an exemplary one, or all, of the systems of FIGS. 13-15 to create an exemplary narrative of FIG. 11 according to an exemplary one of the various embodiments of the inventions.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8). The terms “a”, “an”, and “the” as used in the claims herein are used in conformance with long-standing claim drafting practice and not in a limiting way. Unless specifically set forth herein, the terms “a”, “an”, and “the” are not limited to one of such elements, but instead mean “at least one”.

An exemplary embodiment of one of various inventions disclosed herein, and not limiting, includes methods, systems, services and devices for developing a narrative (or narrative statement) which memorializes a person's end-of-life health-care planning. A narrative encourages people to memorialize end-of-life planning since most people enjoy developing and telling a story. Furthermore, a narrative resolves the difficulty of making the end-of-life decisions and choices easily and readily understood particularly in contrast to legalistic documents, such as “advanced directives,” which have been plagued with numerous problems discussed subsequently. Still further, an exemplary one embodiment of various inventions disclosed herein, and not limiting, includes methods, systems, services and devices for developing and saving the narrative on a data storage device and includes a server readily accessible via the internet. This resolves the difficulty of making the narrative (memorialized end-of-life health-care planning) easily and readily accessible and/or irretrievable since most people have access to the internet.

An exemplary one embodiment of various inventions disclosed herein, and not limiting, includes methods, systems and devices for developing a list (or plurality) of categories each comprised of questions. Answers to the questions are collected and coordinated to ultimately define an individual's acceptable “quality of life” in a narrative form. The narrative will include personal value judgments and statements directed to specific aspects of life, and more specifically, to end-of-life health-care decisions and choices.

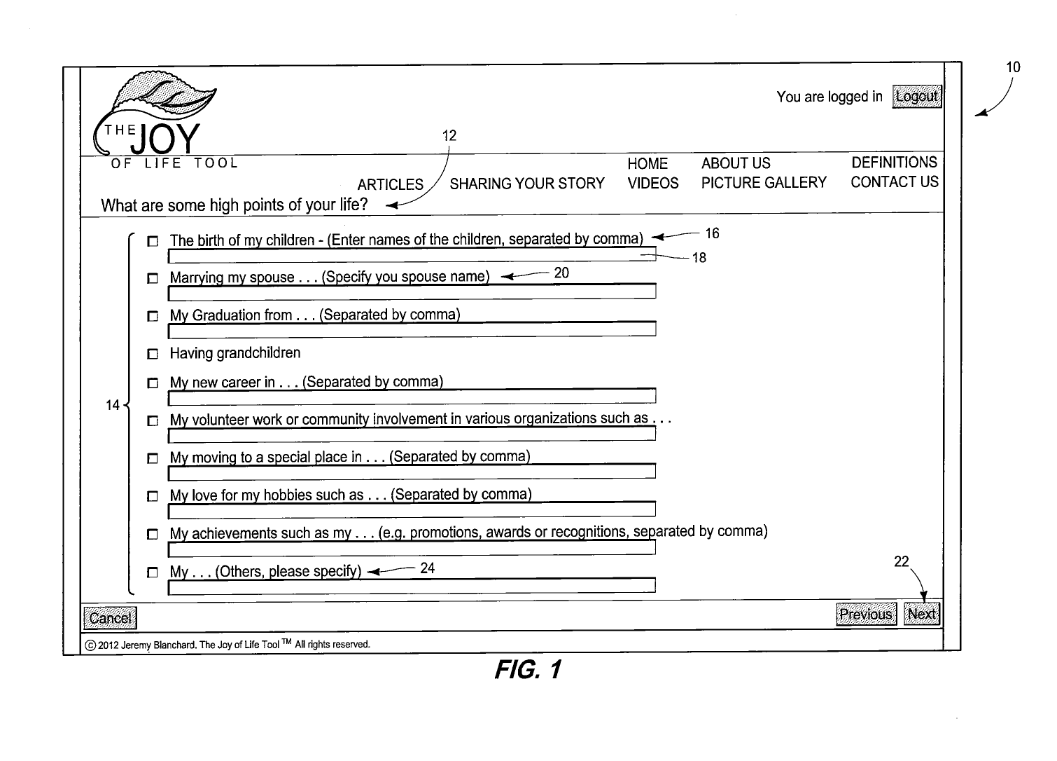

Referring to FIG. 1, an inventive device according to one of various inventions is illustrated and includes a page or document 10 having at least one question. Furthermore, the exemplary document 10 includes a collection of questions comprising a category 12 of questions. One exemplary page or document 10 is a hypertext document or web document (hereinafter routinely referred to as a web document or web page 10). The web document 10 further includes at least one proposed answer or statement for the at least one question or category 12. For still another embodiment of the invention, web document 10 further includes a series 14 of proposed answers or statements. In one embodiment it should be understood that the web document 10 is presented to be viewed on a computer display or screen (not shown here). Other embodiments of the invention include document 10 as being a page from a printing device and provided in a pamphlet, magazine or booklet.

Still referring to FIG. 1, an exemplary first question or category 12 according to an embodiment of the invention includes: “What are some high points of your life?” Still further, a first exemplary proposed answer or statement 16 according to an embodiment of the invention and directed to defining the first question 12 includes: “The birth of my children.”

Still referring to FIG. 1, another exemplary embodiment of the invention includes the method wherein a person or customer provides information personal to that customer in, for example, a blank space 18 which creates the first proposed answer or statement 16 to the first category or question 12. Alternatively, the customer can skip the first proposed answer or statement 16 to the first category or question 12 and not provide personal information and move to review an exemplary second answer or statement 20 to the first category or question 12. An exemplary embodiment of the method includes the customer reviewing each proposed answer or statement that represent collectively the series 14 of answers or statements that define the first category or question 12. The customer will selectively provide personal information to, or skip, each answer or statement that define the first category or question 12.

Still referring to FIG. 1, the method according to another aspect of the invention is to provide the capability for the customer to selectively alter or modify one or more of the proposed answers or statements that define the category or question. By allowing this capability, the personal and individualistic nature of answers or statements is realized to more thoroughly develop the customer's own acceptable “quality of life” and value statement. In the interest of further developing the customer's own acceptable “quality of life” and value statement, the method of the invention further includes the capability for the customer to selectively alter or modify one or more of the categories or questions.

Still referring to FIG. 1, the method according to another aspect of the invention is to provide the capability for the customer to selectively add or delete one or more of the proposed answers or statements that define the category or question. By allowing this capability, the personal and individualistic nature of answers or statements is realized to more thoroughly develop the customer's own acceptable “quality of life” and value statement. In the interest of further developing the customer's own acceptable “quality of life” and value statement, the method of the invention further includes the capability for the customer to selectively add or delete one or more of the categories or questions. One exemplary method for adding a proposed answer to the series 14 of answers is illustrated wherein the following request 24 is presented: “Others, please specify.”

Still referring to FIG. 1, another inventive method step according to an embodiment of the invention includes an indication of the capability to move or access another page or web document to view. For one of various embodiments of the invention, a prompt icon 22 exists and is shown on the current web document 10 which reads “next.” When the “next” icon 22 is selected, another hypertext document is accessed containing new and different information to be viewed on the computer screen or display.

Various methods for selecting the “next” icon 22 are possible including moving a pointer (not shown) of a alpha-numeric key set of a computer or of a mouse device to the “next” icon 22 and clicking via the “enter” key (not shown) of computer or mouse device. Alternatively, the “next” icon 22 can be selected by literally touching the computer screen at the location of display where the “next” icon 22 is positioned. Another aspect of the inventive method includes moving to the “next” page of a booklet by turning the page.

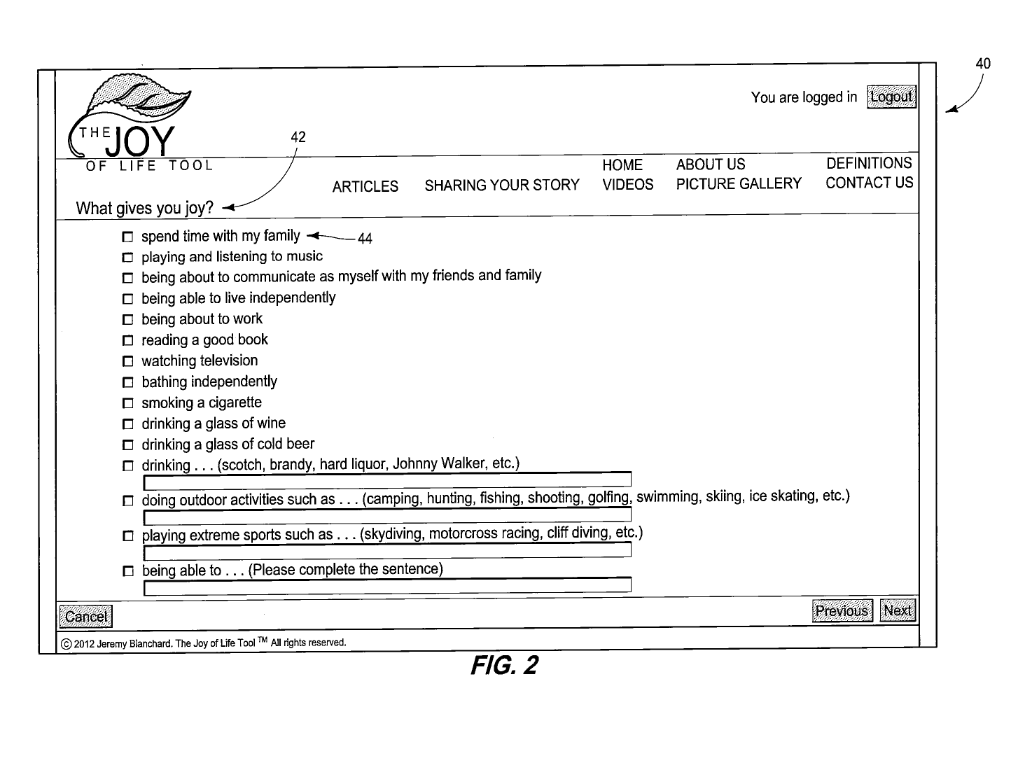

Referring to FIG. 2, the “next” icon 22 from FIG. 1 has been selected and another hypertext document 40 is accessed containing new and different information to be viewed on the computer screen or display. Hypertext document 40 or page according to an embodiment of the method includes developing an exemplary second question or category 42 directed ultimately to define an individual's acceptable “quality of life” or value statement. One exemplary embodiment of the invention includes the method of further developing one or more first proposed answers or statements 44 that are directed to defining the second question or category 42 in a personal or individualistic context. A second exemplary question or category 42 according to an embodiment of the invention includes: “What gives you joy?” Still further, a first exemplary proposed answer or statement 44 according to an embodiment of the invention directed to defining the exemplary second question or category 42 includes: “spend time with my family.”

It should be understood that any of the various different aspects and embodiments of the inventive method described herein and throughout this document are applicable to any one of the exemplary questions or categories discussed herein and throughout this document. Moreover, any of the various different aspects and embodiments of the inventive method described herein and throughout this document are applicable to any one of the exemplary series of answers or statements discussed herein and throughout this document. For example, an aspect of the method includes providing the capability of allowing the customer to selectively add, delete or modify one or more of the questions or categories and answers or statements discussed herein and throughout this document.

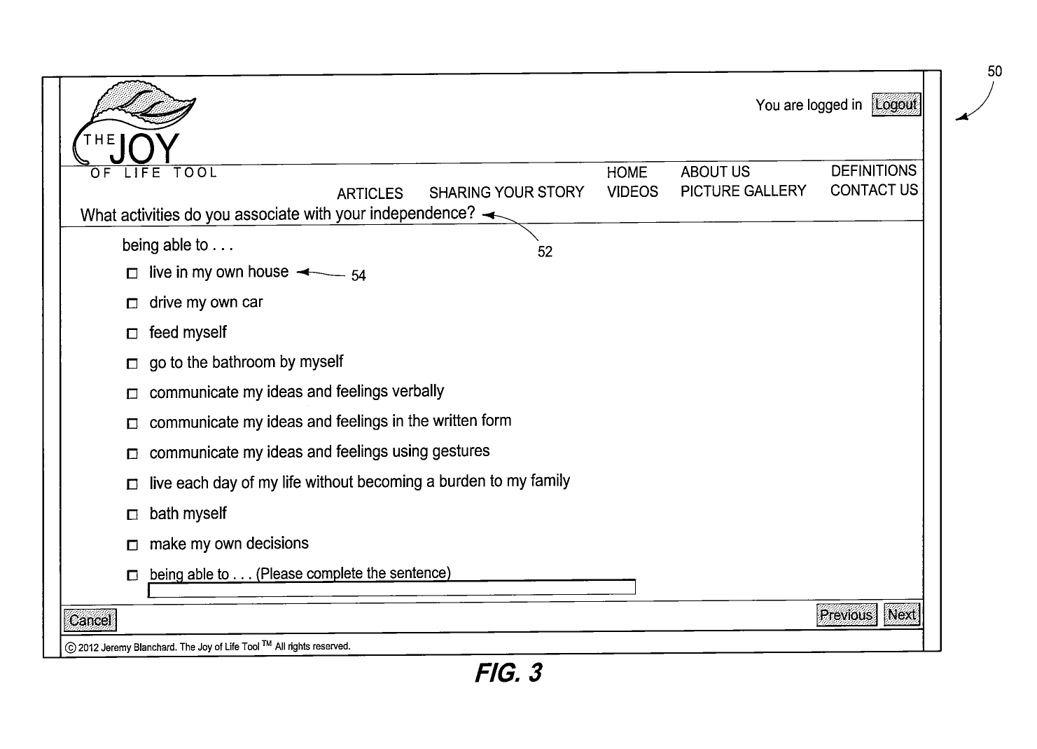

Referring to FIG. 3, the “next” icon from FIG. 2 has been selected and another hypertext document 50 is accessed containing new and different information to be viewed on the computer screen or display. Hypertext document 50 or page according to an embodiment of the method includes developing an exemplary third question or category 52 directed ultimately to define an individual's acceptable “quality of life” or value statement. One exemplary embodiment of the invention includes the method of further developing one or more first proposed answers or statements 54 that are directed to defining the third question or category in a personal or individualistic context. A third exemplary question or category 52 according to an embodiment of the invention includes: “What activities do you associate with your independence?” Still further, a first exemplary proposed answer 54 or statement according to an embodiment of the invention directed to defining the exemplary third question or category 52 includes: “being able to live in my own house.”

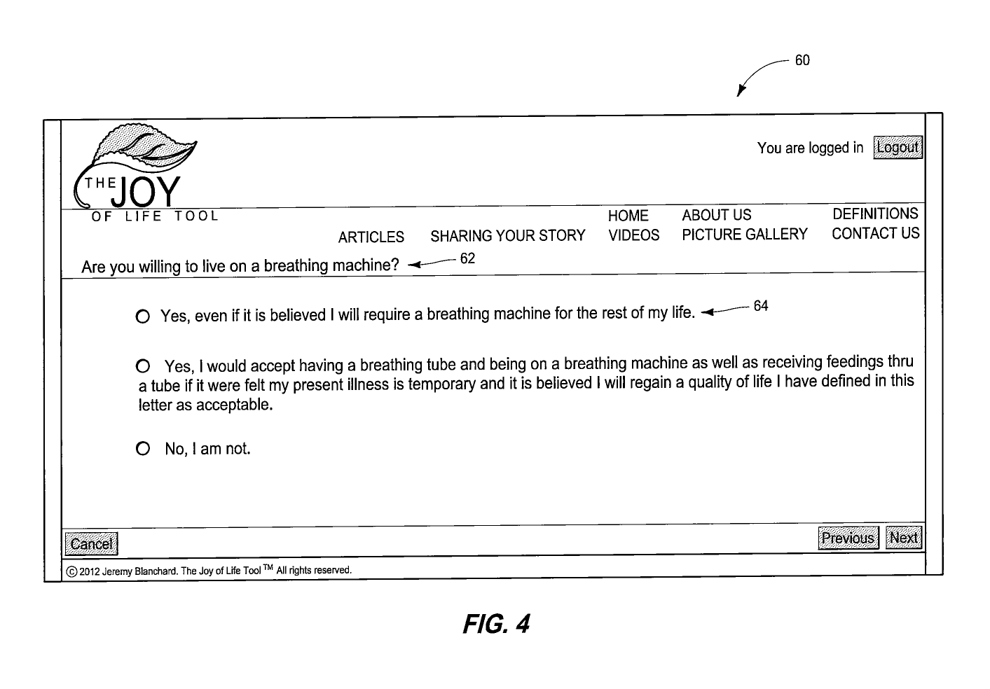

Referring to FIG. 4, the “next” icon from FIG. 3 has been selected and another hypertext document 60 is accessed containing new and different information to be viewed on the computer screen or display. Hypertext document 60 or page according to an embodiment of the method includes developing an exemplary fourth question or category 62 directed ultimately to define an individual's acceptable “quality of life” or value statement. One exemplary embodiment of the invention includes the method of further developing one or more first proposed answers or statements 64 that are directed to defining the fourth question or category 62 in a personal or individualistic context. A fourth exemplary question or category 62 according to an embodiment of the invention includes: “Are you willing to live on a breathing machine?” Still further, a first exemplary proposed answer or statement 64 according to an embodiment of the invention directed to defining the exemplary fourth question or category 62 includes: “Yes, even if it is believed I (sic) will require a breathing machine for the rest of my life.”

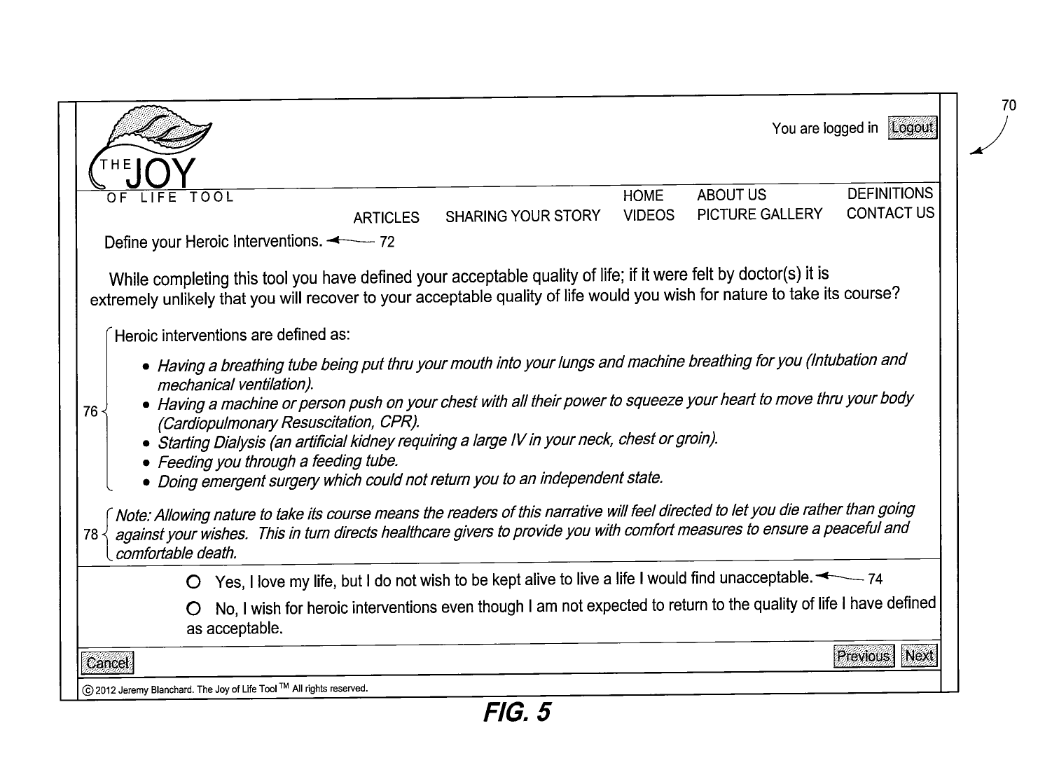

Referring to FIG. 5, the “next” icon from FIG. 4 has been selected and another hypertext document 70 is accessed containing new and different information to be viewed on the computer screen or display. Hypertext document 70 or page according to an embodiment of the method includes developing an exemplary fifth question or category 72 directed ultimately to define an individual's acceptable “quality of life” or value statement. One exemplary embodiment of the invention includes the method of further developing one or more first proposed answers or statements 74 that are directed to defining the fifth question or category 72 in a personal or individualistic context. A fifth exemplary question or category 72 according to an embodiment of the invention includes: “Define your heroic Interventions.” Still further, a first exemplary proposed answer or statement 74 according to an embodiment of the invention directed to defining the exemplary fifth question or category 72 includes: “Yes, I love my life, but I do not wish to be kept alive to live a life I (sic) would find unacceptable.” For one exemplary embodiment of the invention, the web document 70 includes a series 76 of heroic interventions being defined. Moreover, another exemplary embodiment of the invention includes the web document 70 having a cautionary note 78 of the repercussions for not allowing for heroic interventions.

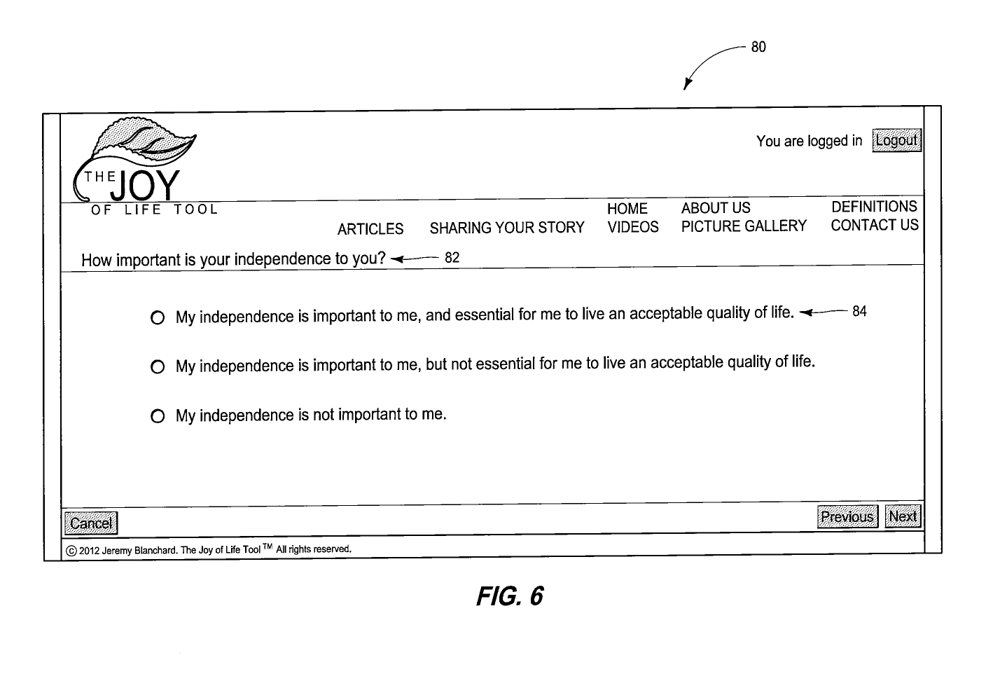

Referring to FIG. 6, the “next” icon from FIG. 5 has been selected and another hypertext document 80 is accessed containing new and different information to be viewed on the computer screen or display. Hypertext document 80 or page according to an embodiment of the method includes developing an exemplary sixth question or category 82 directed ultimately to define an individual's acceptable “quality of life” or value statement. One exemplary embodiment of the invention includes the method of further developing one or more first proposed answers or statements 84 that are directed to defining the sixth question or category 82 in a personal or individualistic context. A sixth exemplary question or category 82 according to an embodiment of the invention includes: “How important is your independence to you?” Still further, a first exemplary proposed answer or statement 84 according to an embodiment of the invention directed to defining the exemplary sixth question or category 82 includes: “My independence is important to me, and essential for me to live an acceptable quality of life.”

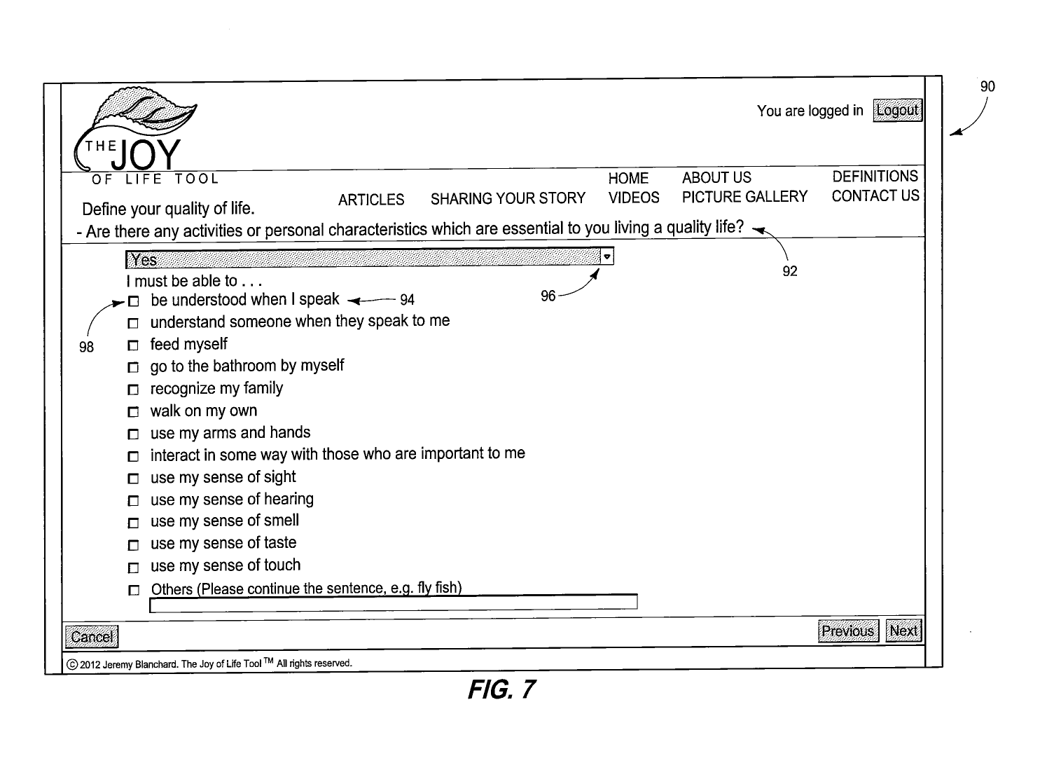

Referring to FIG. 7, the “next” icon from FIG. 6 has been selected and another hypertext document 90 is accessed containing new and different information to be viewed on the computer screen or display. Hypertext document 90 or page according to an embodiment of the method includes developing an exemplary seventh question or category 92 directed ultimately to define an individual's acceptable “quality of life” or value statement. One exemplary embodiment of the invention includes the method of further developing one or more first proposed answers or statements 94 that are directed to defining the seventh question or category 92 in a personal or individualistic context. A seventh exemplary question or category 92 according to an embodiment of the invention includes: “Are there any activities or personal characteristics which are essential to you living a quality life?” Still further, a first exemplary proposed answer or statement 94 according to an embodiment of the invention directed to defining the exemplary seventh category or question 92 includes a “pull down” option 96 for answering either yes or no. If answering yes, then the customer reviews the first exemplary statement 94 presented as, “I must be able to . . . be understood when I speak” and makes the decision whether or not to select the check prompt 98 for answer 94. The customer then continues to make the decision whether to select any one of the other check prompts (not referenced) associated with other proposed/exemplary answers (not referenced).

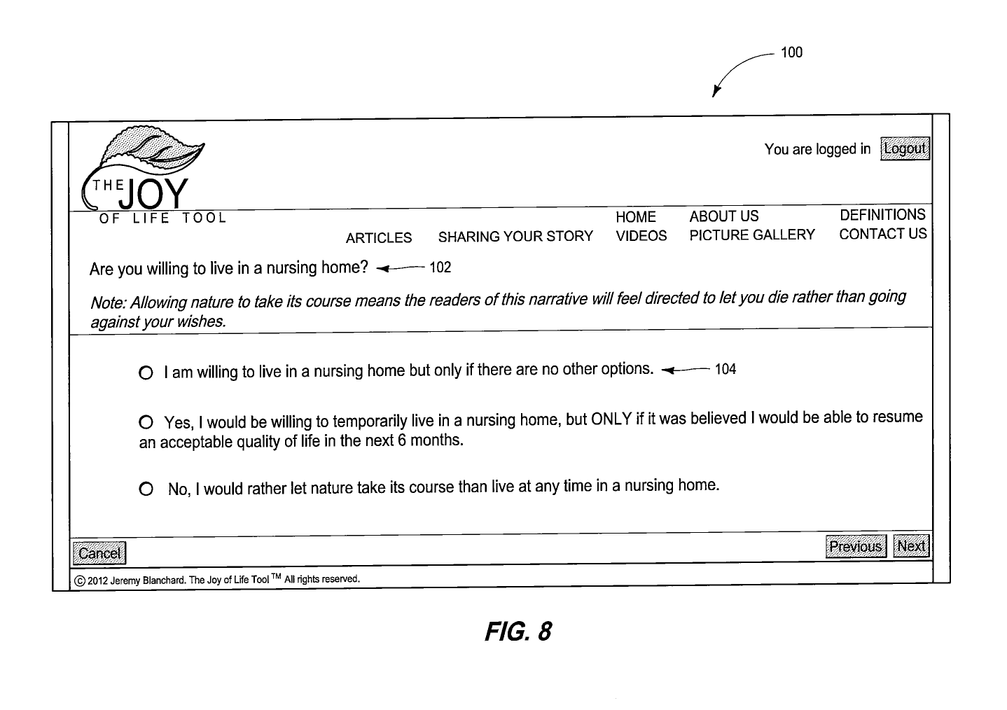

Referring to FIG. 8, the “next” icon from FIG. 7 has been selected and another hypertext document 100 is accessed containing new and different information to be viewed on the computer screen or display. Hypertext document 100 or page according to an embodiment of the method includes developing an exemplary eighth question or category 102 directed ultimately to define an individual's acceptable “quality of life” or value statement. One exemplary embodiment of the invention includes the method of further developing one or more first proposed answers or statements 104 that are directed to defining the eighth question or category 102 in a personal or individualistic context. An eighth exemplary question or category 102 according to an embodiment of the invention includes: “Are you willing to live in a nursing home?” Still further, a first exemplary proposed answer or statement 104 according to an embodiment of the invention directed to defining the exemplary eighth question or category 102 includes: “I am willing to live in a nursing home but only if there are no other options.”

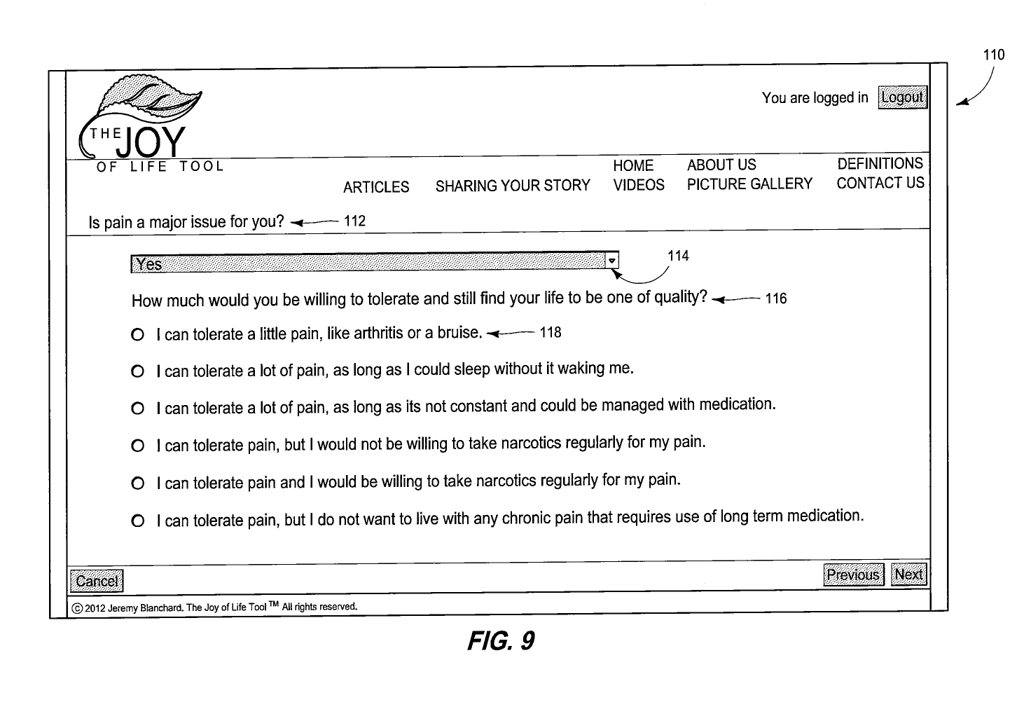

Referring to FIG. 9, the “next” icon from FIG. 8 has been selected and another hypertext document 110 is accessed containing new and different information to be viewed on the computer screen or display. Hypertext document 110 or page according to an embodiment of the method includes developing an exemplary ninth question or category 112 directed ultimately to define an individual's acceptable “quality of life” or value statement. A ninth exemplary question or category 112 according to an embodiment of the invention includes: “Is pain a major issue for you?” A first exemplary proposed answer or statement 114 according to an embodiment of the invention directed to defining the exemplary ninth category or question 112 includes a “pull down” option 114 for answering either yes or no. Additionally, for another embodiment of the invention, this exemplary hypertext document 110 includes another question or category 116: “How much would you be willing to tolerate and still find your life to be one of quality?” In response to the another question or category 116, another exemplary proposed answer or statement 118 is presented as: “I can tolerate a little pain, like arthritis or a bruise.”

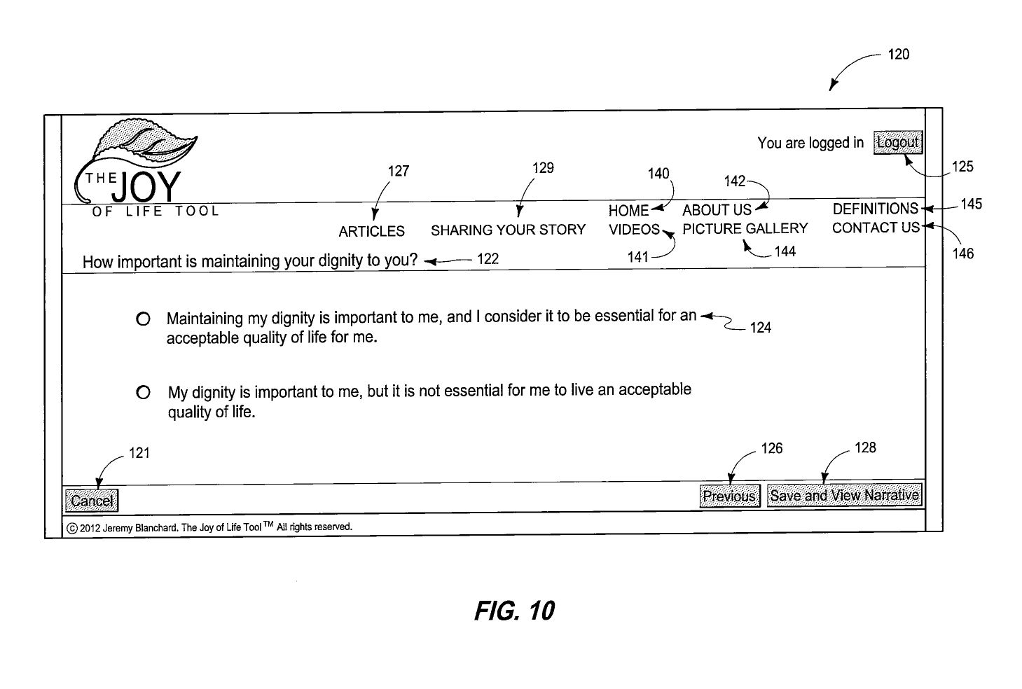

Referring to FIG. 10, the “next” icon from FIG. 9 has been selected and another hypertext document 120 is accessed containing new and different information to be viewed on the computer screen or display. Hypertext document 120 or page according to an embodiment of the method includes developing an exemplary tenth question or category 122 directed ultimately to define an individual's acceptable “quality of life” or value statement. One exemplary embodiment of the invention includes the method of further developing one or more first proposed answers or statements 124 that are directed to defining the tenth question or category 122 in a personal or individualistic context. A tenth exemplary question or category 122 according to an embodiment of the invention includes: “How important is maintaining your dignity to you?” Still further, a first exemplary proposed answer or statement 124 according to an embodiment of the invention directed to defining the exemplary tenth category or question 122 includes: “Maintaining my dignity is important to me, and I consider it to be essential for an acceptable quality of life for me.”

Still referring to FIG. 10, it should be understood that according to various embodiments of the invention, any one of the web documents or pages previously discussed (FIGS. 1-10), or any one of the web documents or pages described in this document, can include any one or more of various prompt icons. Exemplary prompt icons include the following exemplary recitations: “next,” “previous” 126, “Cancel” 121, “Logout” 125, “Home” 140, “About Us” 142, “Definitions” 145, “Articles” 127, “Sharing your Story” 129, “Videos” 141, “Picture Gallery” 144, “Contact Us” 146, “Save and View Narrative” 128, “Edit,” “Add New Narrative,” “Operation,” “View/Delete,” “My Profile,” “Change Profile Picture,” “Account Information,” “Edit Profile,” “Change Password,” “About Advanced Directives,” etc. Selecting any one of these prompt icons will access another hypertext or web document (or page) containing new and different information directed to the subject indicated or recited in the prompt icon. For example, selecting the “Definitions” icon 145 will access the web document which contains definitions that are relevant to this web site, that is, relevant to developing a personalized and individualistic narrative (discussed more thoroughly below) directed to a value statements and characteristics of an acceptable quality of life.

Still referring to FIG. 10, an exemplary embodiment of a method according to an embodiment of the invention includes selecting the “Save and View Narrative” icon 128 wherein a “next” hypertext document 150 is displayed.

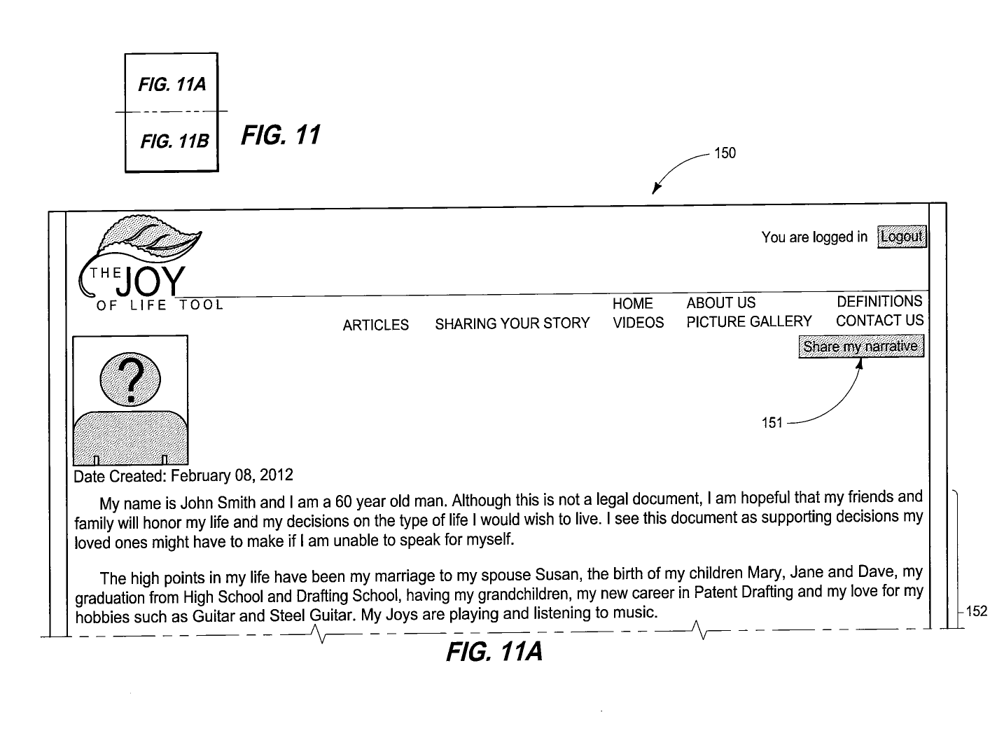

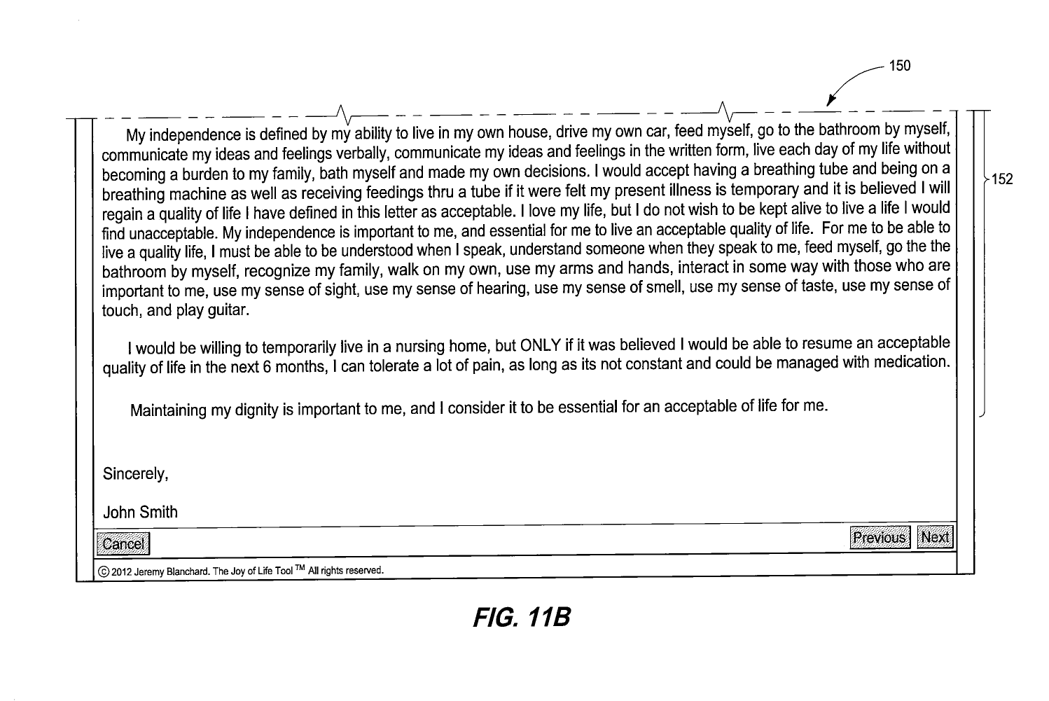

Referring to FIGS. 11A and 11B, an exemplary hypertext document 150 according to one embodiment of the invention is illustrated and is displayed after selection of the “Save and View Narrative” icon 128 shown in FIG. 10. The hypertext document 150 displays an exemplary customer's narrative statement 152 that has been created or developed by the inventive method and is an inventive device representing a personalized and individualistic statement by the customer.

An exemplary embodiment of a narrative format or narrative template 250 is created or developed and saved on, for example, a data storage device, for example, a database. In this manner, the narrative template can to be selectively recalled when desired and used, such as by a computer. An exemplary narrative template 250 includes text in a paragraph format and blank spaces interspersed throughout the format. According to an embodiment of the inventive method, the customer's previously presented answers and statements in the previously described hypertext documents are inputted or incorporated into the blank spaces of the narrative template 250 to ultimately establish the narrative statement. The following is one example of a narrative template 250 according to an embodiment of the invention:
My name is (blank space 251) and I am a (blank space 252) year old (blank space 253). Although this is not a legal document, I am hopeful that my friends and family will honor my life and my decisions on the type of life I would wish to live. I see this document as supporting decisions my loved ones might have to make if I am unable to speak for myself.
The high points in my life have been my (blank space 254). My joys are (blank space 255).
My independence is defined by my ability to (blank space 256). For me to be able to live a quality life, I must be able to (blank space 257).
(blank space 258).
(blank space 259).

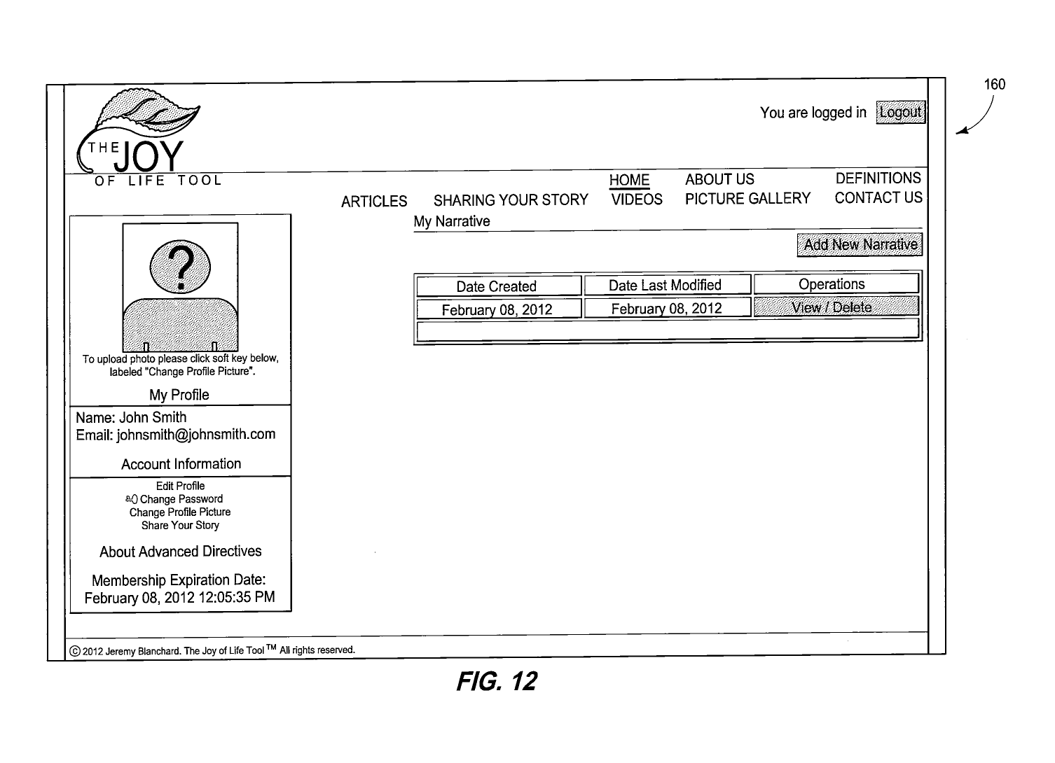

Regarding to the above exemplary narrative template 250, information to be provided in blank space 251 can be acquired from, as one example, an account profile provided by a customer wherein an exemplary one is illustrated in FIG. 12 and described below. Information to be provided in blank spaces 252 and 253 is acquired from, as one example only, the account profile. Information to be provided in blank space 254 is acquired from, as one example only, the web document shown in FIG. 1. Information to be provided in blank space 255 is acquired from, as one example only, the web document shown in FIG. 2. Information to be provided in blank space 256 is acquired from, as one example only, the web documents shown in FIGS. 3-6. Information to be provided in blank space 257 is acquired from, as one example only, the web document shown in FIG. 7. Information to be provided in blank space 258 is acquired from, as one example only, the web documents shown in FIGS. 8-9. Information to be provided in blank space 259 is acquired from, as one example only, the web document shown in FIG. 10.

The inventive method for developing the customer's narrative statement 152 is conducted by, as one exemplary method step, by a software program that accesses the questions having answers and statements provided by the customer, collects the answers and statements, and reconfigures the information gleaned from the answers and statements and incorporates into the narrative template to ultimately establish the narrative statement 152. It should be understood that the software program can be configured by those skilled in the art to provide the functionality described as being performed by the software program.

Consequently, the narrative statement 152 is directed to the customer's own value system specifically personalized and individualized accurately defining the customer's acceptable quality of life, and more particularly, the customer's end-of-life choices and decisions. The narrative statement 152 is readily accessible for viewing and printing via the internet and can be used to inform and articulate the patient's (previously customer) value statements, end-of-life choices and decisions, and acceptable characteristics for a quality of life to family members, and ultimately, to healthcare providers. With the narrative statement 152 being readily accessible via the internet, a patient's end-of-life planning is readily discernible ultimately to a healthcare provider when the patient is incapacitated. The narrative statement 152 relieves decision-makers, routinely family members, of the burden of guessing at what the patient's value statements, end-of-life choices and decisions and acceptable characteristics for a quality of life would be.

In one exemplary embodiment of the invention, the narrative statement 152 is not a legal document. Alternatively, the narrative statement 152 can include legal language that transform the document into a legal document.

Referring to FIG. 12, an exemplary embodiment of the invention includes a web document 160 that is directed to membership status, or account profile, and indicates whether a customer is a member, and if yes, whether the member is in good standing. Alternatively, if the customer is not yet a member, or was a member and is currently not in good standing, the web document will direct the customer to how to become a member or how to be reinstituted as membership in good standing. It should be understood that any one of the web documents discussed previously including this one, web document 160, can be presented in any order including this one being presented first.

Still referring to FIG. 12, an exemplary embodiment of the invention includes a method that provides the capability for allowing a customer to edit or modify a previously created narrative statement 152 (FIGS. 11A and 11B) at any selected time desired by the customer. An exemplary editing or modifying method step according to one of various embodiments of the invention includes changing any one or more of the current questions or changing any one or more of the current answers. Another exemplary editing or modifying method step according to another one of various embodiments of the invention includes adding or deleting any one or more of the current questions or current answers. One advantage of this method step is the simplicity to modify, change and update the narrative statement to ultimately reflect continual development, maturing and changing of a person's values and end-of-life choices and decisions. Still another exemplary editing or modifying method step according to one of various embodiments of the invention includes changing or modifying the narrative template.

The narrative statement 152 (FIGS. 11A and 11B) resolves all the barriers discussed previously in the Background of this document for developing end-of-life choices and decisions which routinely occur or develop using “advanced directives.” As an example, the narrative statement is not written in legalistic terms or with legal requirements that significantly discourage use of “advanced directives.” There are no health care agent or surrogate restrictions such as that which currently exists in 40 states wherein the advanced directive do not allow for same-sex partners as default surrogates. Moreover, no execution requirements are needed to make forms legally valid such as in 35 states which do not allow oral advance directives, and 48 states require witness signatures, a notary public, or both which is a substantial burden for some and can reasonably be characterized as impossible for others.

Still further, the narrative statement is routinely a single page produced at an elementary-school level language. Therefore, the content-related barriers that exist in Federal and State “advance directives,” including poor readability, are rendered moot. Accordingly, people that are most vulnerable, and arguably the most in need of the inventive narrative statement described in this document, and which include the elderly and poor with limited literacy and/or limited English proficiency, are able to read and comprehend the narrative statement.

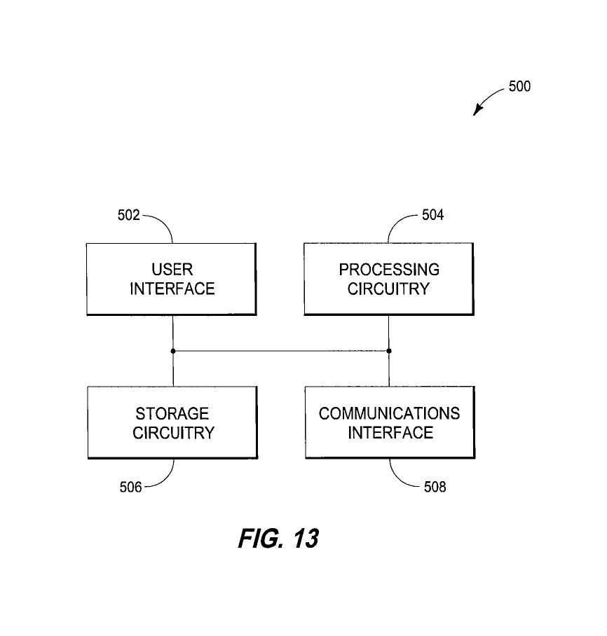

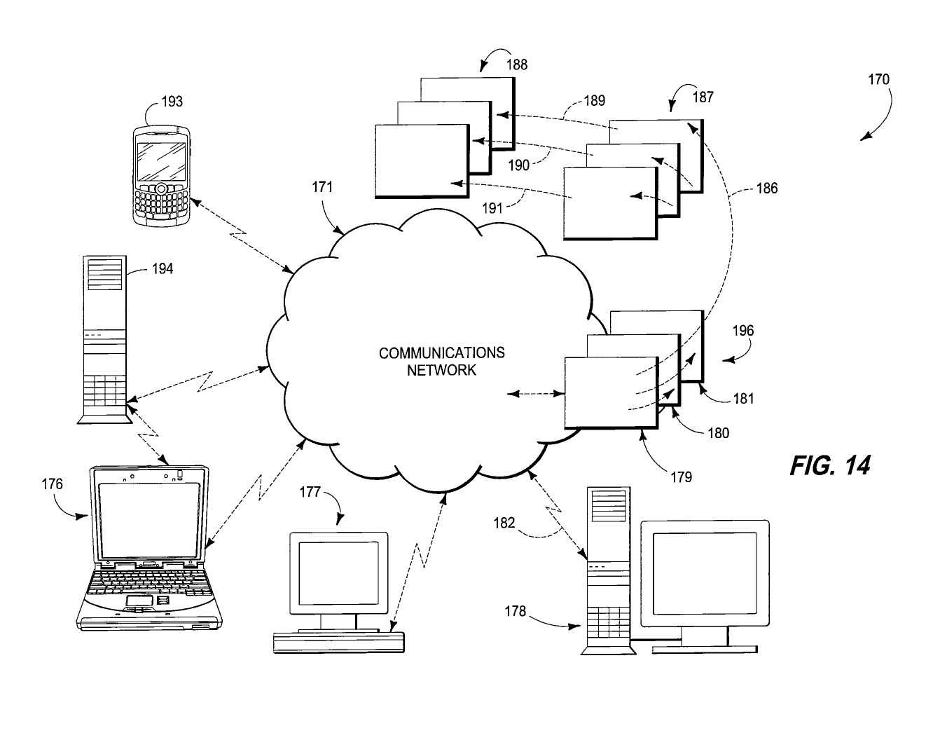

Referring to FIG. 13, an exemplary control circuitry 500 is illustrated according to one of various embodiments of the invention. In an exemplary embodiment, the control circuitry 500 stands alone without additional structure and circuitry to implement the previously presented and subsequently presented inventive methods, systems and devices (as examples only, and without limitation, shown in FIGS. 1-12 and 14-17). In another embodiment, the control circuitry 500 is integrated into an exemplary overall environment or system such as system 170 described and discussed more thoroughly below with respect to FIG. 14.

Still referring to FIG. 13, in the illustrated example embodiment, control circuitry 500 includes a user interface 502, processing circuitry 504, storage circuitry 506, and a communications interface 508. Other embodiments of control circuitry 500 are possible including more, less and/or alternative components.

User interface 502 is configured to interact with a user including conveying data to a user (e.g., displaying visual images for observation by the user) as well as receiving inputs from the user. For example, user interface 502 may convey status information and receive user commands regarding operations of system 170 (again, described and discussed more thoroughly below with respect to FIG. 14).

In one embodiment, processing circuitry 504 is arranged to process data, control data access and storage, issue commands, and control other desired operations. Processing circuitry 504 may comprise circuitry configured to implement desired programming provided by appropriate computer-readable storage media in at least one embodiment, for example, a database. For example, the processing circuitry 504 may be implemented as one or more processor(s) and/or other structure configured to execute executable instructions including, for example, software and/or firmware instructions. Other exemplary embodiments of processing circuitry 504 include hardware logic, PGA, FPGA, ASIC, state machines, and/or other structures alone or in combination with one or more processor(s). These examples of processing circuitry 504 are for illustration and other configurations are possible.

Processing circuitry 504 may also manage power flows. For example, the processing circuitry 504 may access information from a plurality of sources and control how electrical energy is received and supplied with respect to using the information.

Storage circuitry 506 (for example, a database) is configured to store programming such as executable code or instructions (e.g., software and/or firmware), electronic data, databases, image data, or other digital information and may include computer-readable storage media. At least some embodiments or aspects described herein may be implemented using programming stored within one or more computer-readable storage medium of storage circuitry 506 and configured to control appropriate processing circuitry 504.

The computer-readable storage medium may be embodied in one or more articles of manufacture which can contain, store, or maintain programming, data and/or digital information for use by or in connection with an instruction execution system including processing circuitry 504 in the exemplary embodiment. For example, exemplary computer-readable storage media may be non-transitory and include any one of physical media such as electronic, magnetic, optical, electromagnetic, infrared or semiconductor media. Some more specific examples of computer-readable storage media include, but are not limited to, a portable magnetic computer diskette, such as a floppy diskette, a zip disk, a hard drive, random access memory, read only memory, flash memory, cache memory, and/or other configurations capable of storing programming, data, or other digital information.

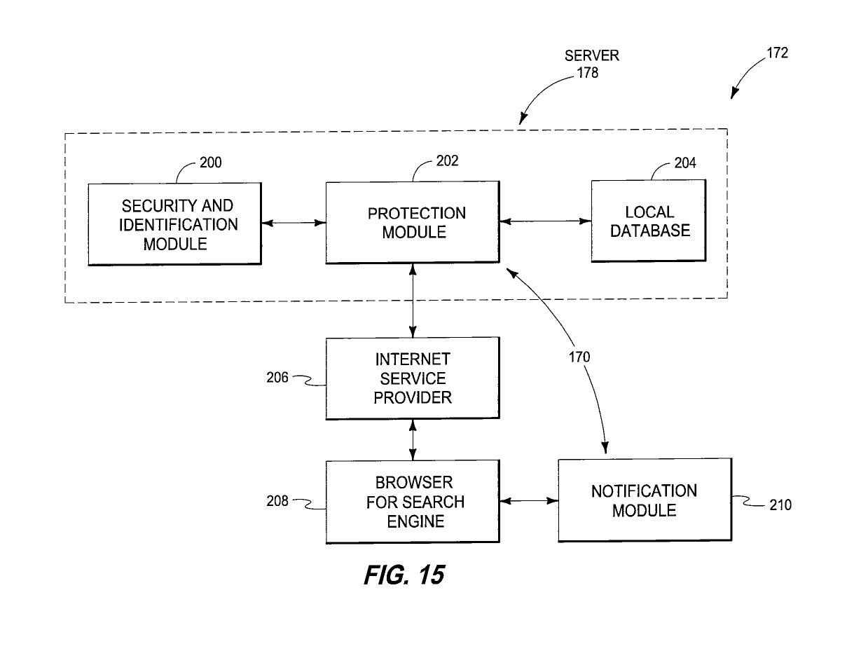

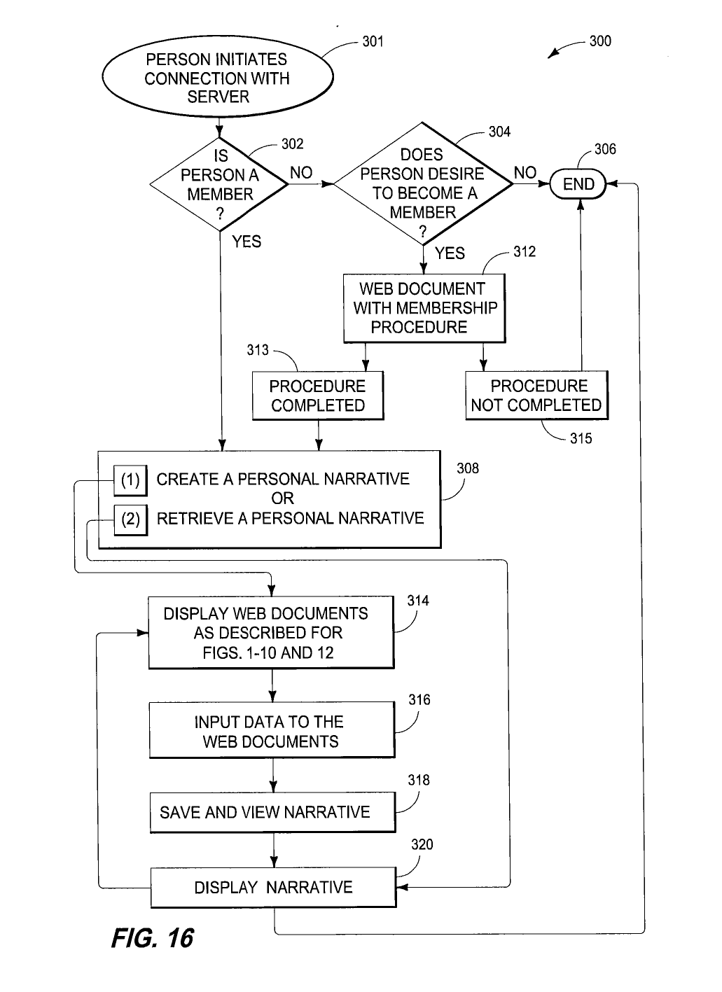

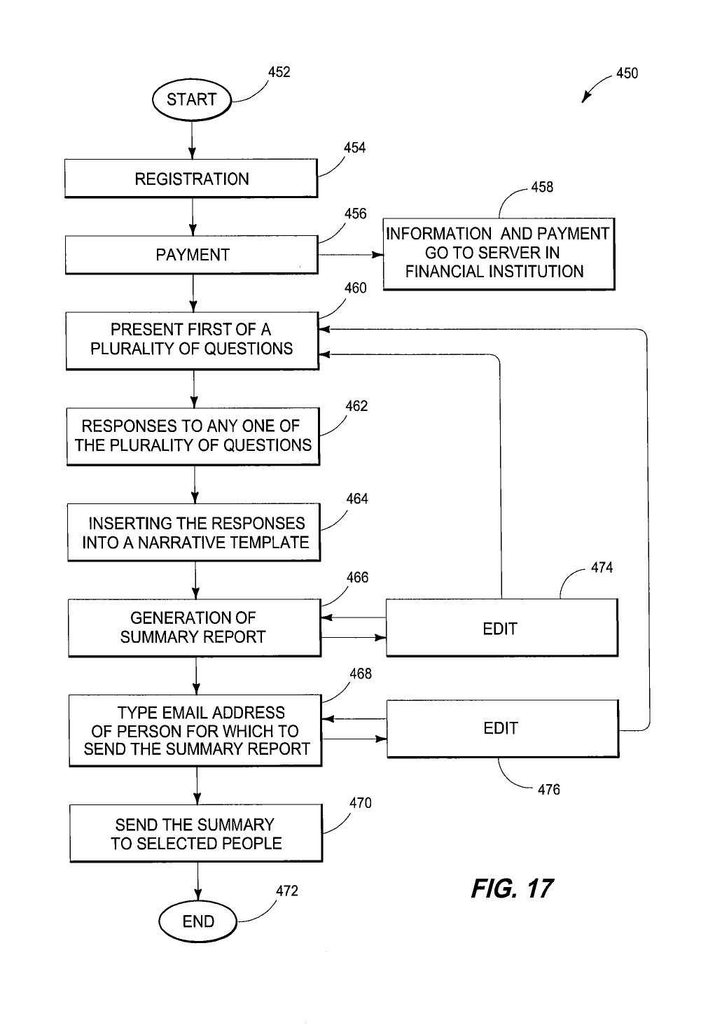

Communications interface 508 is arranged to implement communications of control circuitry 500 with respect to other devices and networks, such as other control circuits and communications networks (see FIG. 14 and associated discussion). It should be understood that control circuitry 500 can be integrated in systems of FIGS. 14-15, integrated into methods of FIGS. 16-17 and integrated to implement use of web documents of FIGS. 1-12.

Referring to FIG. 14, an exemplary overall environment or system 170 is illustrated according to one of various embodiments of the invention. An exemplary system 170, in one embodiment, is implemented by the previously described control circuitry 500. Moreover, in one embodiment, the exemplary system 170 implements the previously presented and described inventive methods and devices (as examples only, and without limitation, shown in FIGS. 1-13) in an ecommerce environment as an exemplary Electronic business transaction (eBusiness). Electronic business or eBusiness is a business that performs commerce (ecommerce), exchange of products and services, over the internet or online. The overall system 170 includes an exemplary cloud-like communication network 171 comprised of communication lines, switches connecting servers and gateways in various combinations. In one exemplary embodiment, the servers (including host servers 178 and 194) and gateways provide the communication access to the www internet. Customers or customers, such as remote internet customers are represented by a variety of computers, such as for example and without limitation, computers 176, 177 and smartphone 193 and can query a host server 178 for the desired information.

Still referring to FIG. 14, the host server 178 accordingly to one embodiment of the invention, could potentially include more than one machine, is connected to the network 171 via a communications link such as a telephone, cable, cell phone link and satellite link, as examples only without limitation. The servers 194 can be connected via high-speed Internet network lines and to other computers and gateways. The servers provide access to stored information such as hypertext or web documents indicated generally at 196, 187 and 188 (as examples only, without limitation, and as described previously in FIGS. 1-12). The hypertext documents 196, 187 and 188 most likely include embedded hypertext link to other locally stored pages, and as a example only, hypertext document 196 includes hypertext document 179 having embedded hypertext links to local stored web documents 180 and 181 that are stored by any one of exemplary various web servers (or database). Moreover, hypertext documents 186, 189, 190 and 191 are linked to other webs sites or documents 187 and 196 that are stored by any one of exemplary various web servers.

Referring to FIG. 15, such illustrates an exemplary high level architecture according to one of various potential embodiments, showing a system, which can be described as a subsystem 172 of previously described system 170 and includes server 178, used in the context of an Electronic business transaction or eBusiness. Residing on the eBusiness server 178 as part of subsystem 172 is a security and identification module 200, a protection module 202, and a local database 204. The security and identification module 200 is responsible for validating customer access to the server 178. The local database 204 contains information, potentially both public and private. Private information is accessible via the server 178 after customer identification and validation by the security and identification module 200, and includes for example, the previously described narrative 150 and web documents of FIGS. 1-12.

Still referring to FIG. 15, queries initiated by customers, according to an exemplary one of various potential embodiments of the invention, originate at the browser 208 and are transmitted via the local internet service provider 206 to the server 178. Transactions take place between the server 178 and the customer using the browser 208. In operation, a secure transaction between a customer (or a potential customer) represented by the browser 208, and the eBusiness server 178 is initiated by the customer's browser 208 by selecting and entering the URL of the server 178. Communication between the browser 208 and the server 178, using the Internet service provider 206 as an intermediary, gives the customer access to the server 178 and to the web pages and other information residing on the server 178.

Still referring to FIG. 15, and according to an exemplary one of various potential embodiments of the invention, the customer chooses the desired type of secure transaction. At this time the protection module 202, in conjunction with the security and identification module 200, query the customer for information that validates the customer's access privileges. Once the customer's identity and access rights are established, the customer is allowed to pass through the server 178 and to access secure information stored on the local database 204.

Still referring to FIG. 15, and according to an exemplary one of various potential embodiments of the invention, the customer may initiate a business transaction at any time during this connection to the server 178 and gain access to the secure information stored on the local database 204. Information is transferred between the server 178 and the customer's browser 208 by means of the Internet service provider 206. As discussed previously, the customer has the ability to end the session by expressly logging off from the server 178 or by terminating activity at the secure site for a protracted period of time. By either of these two methods the secure connection between the customer's browser 208 and the server 178 is ended and the transaction period terminates. Furthermore, in addition to these two log-off procedures, the subsystem 172 enables what is referred to herein as “implicit log-off.” To this end, a notification module 210 is incorporated as an add-on component to the browser 208. Alternatively, the notification module 210 may be implemented on a proxy server or the business server 178.

Still referring to FIG. 15, in an exemplary embodiment of the invention, the notification module 210 is embedded into the customer browser 208 to intercept and track all hyperlinks through which the customer navigates. Once it recognizes that the customer wishes to exit the secure domain, either expressly by a new domain address which is entered explicitly by the customer, through a bookmark, or through a link from the current site, the notification module 210 will either directly send a notification to the server 178 that will trigger an implicit logoff on the server side, or will pop-up a window to the customer on the customer browser 208, notifying the customer that the current secure session will be terminated, and then take the appropriate action pursuant to the customer's feedback to the pop-up message.

Referring to FIG. 16, an exemplary flowchart is illustrated of a method or process flow 300 according to one embodiment of the invention. An exemplary method 300 includes an eBusiness transaction implemented by the systems of FIGS. 13-15. Method step 301 includes person initiates connection with server. The person includes a potential new customer or client and an old, current or preexisting member. The connection is initiated by a computer, personal computer, smart phone or any device capable of connecting with and activating software/hardware/firmware with a local or remote server, for example, with the eBusiness server that was described previously and via the methods described previously.

After the connection is successfully completed, exemplary method step 302 includes the server providing data to the person's computer which is ultimately displayed on the person's computer screen and includes pop-up questions. Method step 302 includes the question: is person a member? Method step 302 further includes a blank space illustrated on the computer screen provided for the person to enter an answer, either yes or no. Additionally, or alternatively, icons are provided on the computer screen as “no” and “yes” to be selected by the person.

If “no” is selected by the person for the question of method step 302, an exemplary method step 304 includes the following exemplary question being presented on the computer screen: does person desire to become a member?

If “no” is selected by the person for the question of method step 304, an exemplary method step 306 includes the person being notified that the current session or current connection to the eBusiness server will “end,” that is, be terminated.

If “yes” is selected by the person for the question of method step 304, an exemplary method step 312 includes a web document being displayed on the computer screen. An exemplary web document provides membership procedures or instructions for becoming a member. Exemplary instructions include selecting and saving a password which would ultimately be saved on the eBusiness server. Other exemplary instructions include providing a payment procedure for becoming a member, for example, with the use of a personal credit card. Method step 312 further includes determining if any one of the procedures for becoming a member is incorrectly implemented, and if yes, an error message will be displayed with an instruction to repeat the procedure.

An exemplary method step 313 determines the procedure of method step 312 is completed correctly, displays an acknowledgement on computer screen that the procedures for becoming a member are successfully completed, welcomes the new member, and moves to method step 308 (described subsequently).

An exemplary method step 315 determines the procedure of method step 312 is not completed, and if after a period of time no activity to complete the membership procedure occurs, the method step 315 further includes notifying the person that the current session or current connection to the eBusiness server will “end,” that is, be terminated.

If “yes” is selected by the person for the question of method step 302, or membership procedure is successfully completed of method step 313, an exemplary method step 308 includes displaying the following two questions: (1) create a personal narrative? Or (2) retrieve personal narrative?

If question (1) is selected in method step 308, an exemplary method step 314 includes displaying the web documents of FIGS. 1-10 and 12 serially in any order.

An exemplary method step 316 includes allowing the person/customer to input data to any one of the web documents as input to the respective questions as previously described with respect to FIGS. 1-10 and 12. Method step 316 further includes at any time during viewing of any one of the web documents, the person will have the opportunity to put in data that adds new questions, and/or adds new answers whether to existing questions or new questions.

Exemplary method step 318 includes allowing the person, at any time during viewing of any one of the web documents, the opportunity to select the icon “save and view narrative.” Once the “save and view narrative” icon is selected, all the data inputted to all of the web documents with respect to FIGS. 1-10 and 12 is gathered and incorporated into an exemplary narrative template 250 as previously described to ultimately create an exemplary narrative statement as shown and previously described with respect to FIGS. 11A and 11B.

Exemplary method step 320 includes displaying the narrative statement. The narrative statement can be selectively edited and emailed to any person.

Back to step 308, if question (2) is selected in method step 308, method step 320 is implemented to display the current saved version of the person's narrative statement. Method step 320 further includes allowing the person/customer to again implement method steps 314, 318 and 320 to provide the opportunity to modify the narrative statement by selecting any one of the web documents of FIGS. 1-10 and 12 and again entering data to ultimately modify the narrative statement. At any time the eBusiness session can be terminated and the connection with the eBusiness server disconnected as in method step 306.

Referring to FIG. 17, another exemplary flowchart is illustrated of a method or process flow 450 according to another embodiment of the invention. An exemplary method 450 can be implemented by the systems and devices described previously and shown in FIGS. 1-16. An exemplary method step 452 includes for a potential client/customer to initiate a connection to a communications network via a computer, personal computer, smart phone or any communication device capable of connecting with and activating software/hardware/firmware with a local or remote server. An exemplary communications network includes the internet as discussed previously. Accordingly, the method step 452 further includes using a personal computer to access a remote server (for example, an eBusiness server of an eBusiness transaction as described previously) maintained by the inventive service (hereinafter service) described in this document associated with FIGS. 1-16 and corresponding description.

After the connection of method step 452 is successfully completed, the eBusiness server provides data to the personal computer that is displayed as a web document providing instructions for registration, that is, registering as a new member to the service. An exemplary method step 454 includes beginning the process of registering and includes selecting and saving a password on the eBusiness server. This provides for the capability that the new member can access the service as desired once registration is successfully completed.

An exemplary method step 456 includes finalizing the registration process by making a payment for the service.

Method step 456 includes an exemplary method step 458 presents information and the payment to a server in a financial institution via the internet connection. For example, credit card information and the payment amount is sent to the server of the financial institution. The exemplary method step 458 further includes presenting information to the new member on the personal computer as a display of information that the payment has been successfully received and that the registration procedure is successfully completed.

An exemplary method step 460 includes the eBusiness server presenting first of a plurality of questions being displayed on the personal computer. For example, the questions are web documents similar to those presented and described previously with respect to 1-10 and 12 discussed.

An exemplary method step 462 includes providing responses (answers via the personal computer) to any one of the plurality of the questions of method step 460. Method step 462 further includes providing the capability that at any time during viewing of any one of the web documents, the person will have the opportunity to put in data that represents adding new questions, and/or adding new answers, and/or adding new statements.

Exemplary method step 464 includes inserting the responses of method step 462 into a narrative template such as the narrative template previously described with respect to method 300. Method step 464 includes selecting an icon, for example, the “save and view narrative” icon described previously which activates exemplary software (or firmware, or hardware, or any combination thereof) stored, for example, on the eBusiness server (or any storage device). It should be understood that the software can be configured by those skilled in the art to provide the functionality described as being performed by the software. Method step 464 further includes, via activation of the software, to access the narrative template which is stored, for example, on the eBusiness server (or any storage device).

The exemplary method step 466 includes the generation of a summary report implemented by further activation of the software. An exemplary summary report, as one example only, is the same as the narrative statement discussed previously with respect to method 300. Accordingly, the summary report is developed by implementing the software and is produced from the answers incorporated into the narrative template created in method step 464. Method step 266 further includes displaying the summary report on the computer screen. The exemplary summary report includes the narrative statement as shown and previously described with respect to FIGS. 11A and 11B.

Exemplary method step 474 provides the capability to selectively edit the summary report. It should be understood that this can be direct or indirect editing. That is, direct editing of the summary report is where the language of the summary report is presented for modification directly to the summary report document. Regarding the indirect editing, exemplary method step 474 further provides the capability to selectively return to method step 460 and perform again method steps 460, 462, 464 and 466 to ultimately edit, indirectly, the summary report which was originally produced. It should be understood that this indirect editing is performed by modifying the questions of method step 460 and/or by modifying the answers of method step 462. This method step 474 of editing, directly or indirectly, can be performed as many number of times as desired.

Exemplary method step 468 includes displaying a web document that allows the member to create and store a list of people on a server, for example the eBusiness server. The list of people can be created for any purpose, for example, the people who need to be notified when the member is critically ill, and/or people who have a copy of the summary report, and/or a decision-maker who will have to make those decisions for the member when he or she is critically ill and cannot communicate their end-of-life choices and decisions.

Exemplary method step 476 provides the capability to selectively edit the list of people developed in method step 468. Exemplary method step 476 further provides the capability to selectively return to method step 460 and perform again method steps 460, 462, 464 and 466 to ultimately edit, indirectly, the summary report which was originally produced (or modify or amend the list of people). This method step 476 of editing can be performed as many number of times as desired.

Exemplary method step 470 includes sending the summary report to selected people via the internet in an email. Ultimately, the people with the summary report (narrative statement) can present the end-of-life desires, wishes, choices and decisions to a health care provider when the member cannot communicate for whatever reason.

Exemplary method step 472 includes an icon, for example, “exit” that allows for the termination of the session with the eBusiness server and the termination of the eBusiness transaction.

It should be understood that the inventive methods 300 and 450 (associated with FIGS. 16 and 17, respectively) and systems described to support and implement the respective methods 300 and 450 can be intertwined so that any one, or any combination of, the method steps, systems and subsystems of method 300 can be used in or as the method steps, systems and subsystems of method 450, and vice versa. Moreover, any statement made regarding the method steps, systems and subsystems of method 300 is applicable to the method steps, systems and subsystems of method 450, and vice versa. It should be further understood that the inventive methods 300 and 450 include questions, statements, templates and narrative statements that are provided at an elementary language level, for example, at a third grade reading level.

It should be understood that this invention has as one, and only one of many, a primary task to encourage discussions (and create/save a narrative statement) about a person's health care for end-of-life planning that ultimately can be used to present to health care providers when the member cannot communicate. The summary report (narrative statement) can be continually updated and referred to by the member or health care provider (via a person who has access to the summary report or narrative statement) to maintain the most updated end-of-life desires, wishes, choices and decisions of a member.

However, the invention is not so limited. It should be understood that another web document, or another set of web documents, directed to different subjects and having questions and proposed answers (and blanks for different answers) as previously described with respect to FIGS. 1-10 and 12 can be presented in the same format. For example, another set of web documents can be directed to the subject of funeral arrangements for the person. Still another set of web documents can be directed to the subject of arrangements for dealing with the person's finances before and after the person dies. Moreover, another set of web documents can be directed to the subject of the person's will. Furthermore, another set of web documents can be directed to the subject of how to handle the person's family home after death.

For each different subject having a different set of web documents would ultimately create a new and different narrative statement. For example, the narrative statement may include separate headings representing the different subjects addressed such as “Funeral Arrangements,” “Finances,” “Will,” and/or “Family Home.”

Encouraging conversations and discussions regarding funeral arrangements before the person dies can avoid conflicts of how such should be handled, and particularly in the matter as desired by the person that has died. Moreover, encouraging conversations and discussions regarding the person's finances before the person dies can locate assets and monies that siblings or children did not know existed which can be used to cover expenses that occur at the end of life relieving monetary burdens on the siblings or children. Furthermore, encouraging conversations and discussions regarding the person's will, particularly about choices and decisions therein, can avoid conflicts such as why one asset was “willed” to one child and not another. For example, one child may receive considerably more assets than other children due to the fact that the one child was a caregiver to the person during his/her declining years. Before the person dies is the time to have this discussion when the person can explicitly provide the reasoning for how assets are divided and hopefully avoid conflict between family members.

Still further, encouraging conversations and discussions regarding the arrangements for the family home can avoid conflicts such as where one child wants the house sold for income while another child who may be living in the home will routinely want to keep the residence. Each of the web documents and narrative statement can be can be created, processed and modified as described previously relative to FIGS. 1-17.

It should be understood that the web documents described in FIGS. 1-10 and 12 and the device comprising a narrative statement illustrated in FIGS. 11A and 11B can be implemented, processed and created on a personal computer wherein the personal computer is substituted as the system replacing the eBusiness system described with respect to FIGS. 13-15. The software for configuring the narrative statement from the input from the person to the respective web documents that include the questions and proposed answers (and blank spaces for different answers from person) can be saved on the hard drive of the person's computer, or the software can be stored on and retrieved from a CD, DVD or memory stick or any other memory device. Alternatively, the software can be downloaded to the person's computer from the eBusiness server over the internet.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

The invention claimed is:

1. A method for encouraging end-of-life planning, the method comprising:
developing a plurality of questions directed to end-of-life issues;
providing the plurality of questions in a format to receive at least one answer; and
incorporating the at least one answer into a template configured to be easily understood.

2. The method of claim 1 wherein the template comprises a narrative.

3. The method of claim 1 further comprising providing the capability to perform at least one of the following steps: adding at least one question to the plurality of questions, editing at least one of the plurality of questions, and deleting at least one of the plurality of questions.

4. The method of claim 1 further comprising providing the capability to edit the answers.

5. The method of claim 1 further comprising providing the capability to edit or develop a new template.

6. A system comprising at least one computer server and computer-readable storage medium accessible by the computer server, the system programmed to preform steps for encouraging end-of-life planning, the steps comprising:
storing a plurality of questions directed to end-of-life issues on the computer-readable storage medium;
formatting the plurality of questions to receive at least one answer;
entering and saving data to the computer-readable storage medium, the data comprising at least one answer to at least one of the plurality of questions; and
incorporating the at least one answer into a template.

7. The system of claim 6 further comprising:
a connection between the system and a communication network; and
a step of communicating with a potential new member via the communication network.

8. The system of claim 6 further comprising a step of providing the plurality of questions to a member.

9. The system of claim 6 wherein the step of incorporating is performed by a program stored on the computer-readable storage medium.

10. The system of claim 6 further comprising the capability to perform at least one of the following steps: adding at least one question to the plurality of questions, editing at least one of the plurality of questions, and deleting at least one of the plurality of questions.

11. A method for encouraging end-of-life planning, the method comprising:
accessing a computer server comprising a computer-readable storage medium;
retrieving a plurality of web documents from the computer server, each web document comprising at least one question directed to end-of-life issues;
entering data into the web documents, the data configured to be at least one answer to at least one of the questions; and
incorporating the at least one answer into a template configured to be easily understood.

12. The method of claim 11 further comprising:
re-accessing the computer server; and
entering additional data to the computer server.

13. The method of claim 11 wherein at least one web document comprises at least one of the following questions: what are some high points of your life, what give you joy, what activities do you associate with your independence, are you willing to live on a breathing machine and how important is your independence to you.

14. The method of claim 11 further comprising editing or modifying at least one of the web documents.

15. The method of claim 11 wherein the incorporating comprises creating a narrative.

16. A system for encouraging end-of-life planning, the system comprising:
a user interface configured to convey and receive data;
processing circuitry configured to process data and implement programming;
storage circuitry configured to store data including programming;
communications interface configured to implement communications between the user interface, processing circuitry and storage circuitry;
questions stored in the storage circuitry and directed to end-of-life issues; and
programming stored in the storage circuitry and configured to convert the answers and questions into a narrative.

17. The system of claim 16 wherein a customer can access the questions and provide answers to the questions.

18. The system of claim 16 wherein a customer can enter answers to the questions and activate the programming to develop the narrative.
